(19) United States
(12) Patent Application Publication
(10) Pub. No.: US 2011/0008175 A1
(43) Pub. Date: Jan. 13, 2011

(54) ROTOR BLADE FOR A WIND TURBINE AND METHOD FOR ITS PRODUCTION

(75) Inventor: Lutz-Reiner Gau, Potsdam (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: NORDEX ENERGY GMBH, Norderstedt (DE)

(21) Appl. No.: 12/697,643

(22) Filed: Feb. 1, 2010

(30) Foreign Application Priority Data
Jul. 7, 2009 (DE) 10 2009 031 947.6

(51) Int. Cl. B64C 11/24; B21K 3/04

(52) U.S. Cl. 416/233; 29/889.72

(57) ABSTRACT

A rotor blade for a wind turbine comprising at least one pair of girders lying opposite each other which extend in the longitudinal direction of the rotor blade and carry forces acting on the rotor blade, and at least one shear web which has two front surfaces, each of which is facing one of the two girders, and two lateral surfaces, wherein that shear web extends between the two girders in the longitudinal direction of the rotor blade and is permanently joined to the two girders, wherein at least one connecting profile having a single- or multi-piece cross-section is running in the longitudinal direction of the rotor blade and comprises a collet, into which the at least one shear web is inserted, wherein a first surface of the connecting profile is glued to one of the girders and a second surface of the connecting profile is glued to a lateral surface of the at least one shear web.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a rotor blade for a wind turbine which has at least one pair of girders lying opposite each other which extend in the longitudinal direction of the rotor blade and carry forces acting on the rotor blade, and at least one shear web which has two front surfaces, each is facing one of the two girders, and two lateral surfaces, wherein that share web extends between the two girders in the longitudinal direction of the rotor blade and is permanently joined to the two girders, and a method for the production of such rotor blades.

Known rotor blades of this design consist of two half shells that are joined to each other. Each half shell has one of the girders usually in the area of the largest profile height. The girders can be produced integrally with the half shells and, among other things, give the rotor blade its bending stiffness among other things. The quality of the joint of the at least one shear web with the girders is very important for the strength of the rotor blade. As a general rule, a large glue bond is established. For this, the shear webs of prior art rotor blades have angled joining sections on their ends facing the girders which are glued to the girders. Both, shear webs with a C-shaped cross-section, where the angled sections form flanges extending to one side of the shear web and shear webs with a double-T-shaped cross-section, where the fastening sections extend to both sides starting from the shear web, are known.

A sufficiently permanent joint to the girders can be achieved with these types of joining sections on the shear webs. However, the installation of the shear webs is difficult. Usually, the entire shear web is first glued to the girder of the first half shell. In order to position the shear web as accurately as possible according to the drawings, a so-called shear web placing device can be used. However, because of the inner contour of the half shell not always being dimensionally stable or of the contact surface of the girder adjacent to the fastening section of the shear web, positioning deviations in the shear web can easily occur. The inaccuracies in the inner contour of the half shells result from the production of the half shells in open molds. In particular, waves or folds can occur during laminating of the glass plies. Then the second half shell is fitted and glued to the first half shell and the shear web. The glue bond is also called a blind glue bond, because after fitting the second half shell large areas are no longer accessible and the quality cannot be checked or is hard to check.

Due to the mentioned tolerances of the inner contours of the half shells and the inaccuracies during the positioning of the shear webs, complex refinishing may be required: If the required inner width between the half shells is fallen short of, the shear webs can lock and make an exact arranging of the two half shells impossible. In this case, the shear web must be cut in in its longitudinal direction and its upper half must be brought into a deeper position by suitable means. The separating cut can then be laminated over on both sides laterally with a specified layer structure. If the required inner width between the two half shells is exceeded, the glue gap for glueing the shear webs and half shell insides can become too large, which can make it necessary to laminate layers on the glue surfaces of the shear webs in order to reduce the gap clearance concerned.

Based on this, the object of the invention is to provide a rotor blade and a method for its production that enables a better joint between the shear webs and the girders of the rotor blade and a simpler and more dimensionally stable assembly of the rotor blade.

### BRIEF SUMMARY OF THE INVENTION

The rotor blade according to the invention for a wind turbine comprises: at least one pair of girders lying opposite each other which extend in the longitudinal direction of the rotor blade and carry forces acting on the rotor blade, and at least one shear web which has two front surfaces, each of which faces one of the two girders, and two lateral surfaces, wherein that shear web extends between the two girders in the longitudinal direction of the rotor blade and is permanently joined with the two girders, wherein at least one connecting profile having a single- or multi-piece cross-section is running in the longitudinal direction of the rotor blade and comprises a collet into which the at least one shear web is inserted, a first surface of the connecting profile is glued to one of the girders and a second surface of the connecting profile is glued to one of said first lateral surface of the at least one shear web.

The two girders can each be joined to with a half shell which forms an outer contour of the rotor blade, or can be integrally produced with it. The girders give the rotor blade its bending stiffness among other things. The rotor blade can have several pairs of girders lying opposite of each other, for example two main girders which are arranged in the area of the largest height of profile, and two trailing edge girders which run in the area of the trailing edge of the profile.

One single shear web or several shear webs can be arranged between each pair of opposite-lying girders. For example, two main girders can be connected by two shear webs arranged at a distance from each other. The two shear webs can be arranged parallel or non parallel to each other. Additionally present trailing edge girders can e.g. be connected by a single shear web.

The at least one shear web can for example have a rectangular or trapezoidal cross-section. However, a cross-section with bent and/or tiered edges, in which the thickness of the shear web can vary, is also possible. Here and below, cross-section always means a cut perpendicular to a longitudinal axis of the rotor blade. The two lateral surfaces of the at least one shear web can each be arranged in a plane which extends from one of the two girders to the opposite-lying girder.

The connecting profile establishes the connection between one of the girders and the at least one shear web. It has a collet, into which the at least one shear web is inserted. The collet should be provided in particular such that it simplifies the correct positioning of the shear web. In particular, the collet can determine the position of the at least one shear web into two or three directions, for example form a boundary to the left, downwards and to the right.

The glue bond of the first surface of the connecting profile with one of the girders and the glue bonding of the second surface of the connecting profile with a first lateral surface of the at least one shear web is preferably a large-area glue bond with a contact surface which is larger than one of the front surfaces of the at least one shear web. This promotes a stable glue bond.

The production and assembly of the rotor blade can be considerably simplified by the invention. In particular, the shear webs can have a simpler geometry than shear webs with angled fastening sections known from the prior art. They can in particular be produced from an even laminate. The connection surfaces between the shear webs and the girders can be dimensioned much more freely through suitable selection of the cross-section of the connecting profile. The connecting profile can easily be produced using industrial methods, in particular in an extrusion process.

Due to the glue bonding of the connecting profile with a lateral surface of the at least one shear web provided according to the invention, deviations in the inner width between the girders no longer gravely impact the quality and geometry of the glue bond between the shear web and the girder, because the frequently unavoidable inaccuracies do not occur in the direction of the clearance between the parts to be glued, as in the case of a conventional glue bond of a fastening flange facing the girder with the girder. Instead, by this invention, such tolerances can easily be counterbalanced by a lateral (with respect to the glue gap) displacement of the parts to be joint. In particular, the shear web can be inserted slightly less deep into the collet of a connecting profile if the inner width is greater than its nominal value, or slightly deeper if the inner width is smaller than its nominal value. A sufficient lateral extension of the glue gap provided, which can be given through suitable selection of the depth of the collet, these corrections have no noteworthy impact on the strength of the glued connection.

The angle between the first lateral surface and the front surface of the at least one shear web can be a right angle or can deviate from a right angle, in particular to allow for a tilt of the shear web with respect to the girder. For example, the first lateral surface and the front surface can inclose an angle in the range of 75° through 105°. The front surface can thereby preferably be arranged parallel to the neighboring girder. Preferably, the same angle can be provided between the first surface of the connecting profile which is glued to the girder and the second surface of the connecting profile which is glued to the first lateral surface of the shear web. In this case, the first lateral surface of the shear web and the second surface of the connecting profile are arranged parallel to each other such that an even glue gap results.

In accordance with one embodiment, the collet is a groove in the connecting profile. The groove can for example have a rectangular cross-section. The lateral surfaces of the groove can also be arranged at an angle with respect to each other or have a different height. The use of a groove as collet makes it possible to exactly position the at least one shear web in the groove.

In accordance with one embodiment, a third surface of the connecting profile is glued to a second lateral surface of the at least one shear web lying opposite the first lateral surface. The result is a double-sided and thus particularly durable glue bond of the shear web.

In one embodiment, the connecting profile has a two-part cross-section and consists of two profiles arranged next to each other. The collet of the connecting profile is then provided between the neighboring profiles. The two neighboring profiles can be glued at a predetermined distance to the girder. The profiles can for example have an angular, triangular or box-shape cross-section.

In accordance with one embodiment, the connecting profile has a one-part cross-section with a U-shaped section which has a base and two legs which form the collet. A connecting profile with a one-part cross-section can be particularly easily glued to the girder, the dimensional accuracy of the collet being ensured by the appropriately exact prefabrication of the connecting profile. The second surface of the connecting profile can be formed by an inside surface of a leg, the third surface of the connecting profile by the inside surface of the opposite-lying leg of the U profile. The legs of the U profile can be aligned parallel to each other. The transitions between the legs and the base of the U profile can be angular or more or less strongly rounded. The transitions of the lateral surfaces to the front surface of the at least one shear web can then also be rounded suitably.

In one embodiment, the first surface of the connecting profile is formed by the outside of the base of the U-shaped section.

In one embodiment, the cross-section of the connecting profile has at least one widening adjacent to the base of the U-shaped section. Only one widening can be provided adjacent to one side of the base of the U-shaped section, while the leg of the U profile distant from this widening forms the lateral end of the connecting profile. However, two widenings may also be provided on both sides of the base of the U-shaped section, so that both legs of the U profile are located at a distance from the lateral edges of the widened base area of the connecting profile. The at least one widening makes possible a more durable glue bond between the connecting profile and the girder, because the surface to be glued is enlarged.

In accordance with one embodiment, the ends of the legs distant from the base in the cross-section of the connecting profile are tilted toward the collet. The tilted surfaces facilitate the insertion of the at least one shear web into the collet of the connecting profile formed between the two legs.

In accordance with one embodiment, a front surface of the at least one shear web is glued to the connecting profile. This enables a further increase in the strength of the glue bond. In the case of a connecting profile with a section with a U-shaped cross-section, the front surface of the at least one shear web can in particular be glued to an inside of a base of the U profile.

In one embodiment, the connecting profile is made of a fiber-reinforced plastic material. This material has a high strength and is particularly beneficial for the glue bond with the girder and the at least one shear web which can also be made of fiber-reinforced plastic material. Profiles made of a fiber-reinforced plastic material can also easily be produced using industrial techniques.

In accordance with one embodiment, several connecting profiles are placed in a row in the longitudinal direction of the rotor blade. Basically, one single connecting profile can be used which extends over the entire length of the rotor blade or of the at least one shear web. However, a connecting profile consisting of several segments is easier to transport and to store. For example, connecting profiles that are several meters long, for example five meters, can be used. The individual segments can be connected to each other using suitable connection means.

In one embodiment, the cross-section of the connecting profile changes in the longitudinal direction of the rotor blade. This solution may be used both with one single connecting profile or with a segmented connecting profile. If several connecting profiles are placed in a row, they can each have a constant cross-section which makes production particularly easy. Alternatively, the cross-section of the connecting profile can change over the entire length continuously or in steps. Particularly useful is a reduction of the height of the connecting profile towards the blade tips, according to the reduction in the height of the at least one shear web.

In one embodiment, the at least one shear web is also joined to the girder lying opposite the first girder using a connecting profile, wherein the connection is designed according to one of the claims described above. In this case, the at least one shear web is both connected to the bottom and to the top shell of the rotor blade by a connecting profile.

The aforementioned object is also achieved by the method for the production of a rotor blade of a wind turbine with the features of claim 14. Advantageous embodiments of the method are specified in the subsequent dependent claims.

The method according to the invention includes the following steps: Providing of a first half shell which comprises a first girder which extends in the longitudinal direction of the rotor blade and carries forces acting on the rotor blade, glueing of a first surface of a connecting profile having a one- or multiple-piece cross-section to the first girder, wherein the connecting profile is arranged in the longitudinal direction of the girder, inserting at least one shear web which has a front surface facing the first girder in a finished rotor blade, and two lateral surfaces, into a collet of the connecting profile, glueing a second surface of the connecting profile to a first lateral surface of the at least one shear web, joining a second half shell which has a second girder lying opposite the first girder in the finished rotor blade, with the first half shell and the at least one shear web.

This method simplifies the production of the rotor blade considerably, in particular because the insertion of the shear web into the connecting profile previously glued to the girder is easy and allows an exact positioning of the at least one shear web.

With respect to the features already discussed in the explanation of the rotor blade according to the invention, we refer to these explanations which are equally valid for the corresponding method.

In accordance with one embodiment of the method, a positioning aid is used for the glue bonding of the first surface of the connecting profile with the first girder and/or the second surface of the connecting profile with the first lateral surface of the at least one shear web. The positioning aid can for example be an optical marking, for example using a laser projection. It can also be a mechanical holder which gives the arrangement of the connecting profile or the at least one shear web with respect to the respective girder or the respective half shell of the rotor blade or of a mold used for the production of said half shell.

In accordance with one embodiment of the method, the collet of the connecting profile is filled with glue up to a predetermined level before inserting the at least one shear web. Basically, the glue can also be applied to the contact surfaces of the at least one shear web to be glued. However, a controlled filling of the collet facilitates the application of the correct amount of glue. By inserting the at least one shear web into the collet at least partially filled with glue, an even distribution of the glue and a good coating of all contact surfaces of the at least one shear web and the connecting profile to be glued are also achieved. Optionally, after filling the collet with glue, the glue arrangement can be secured with a position locking device for preventing dripping or leaking of the glue from the collet. This position locking device, for example a lamellar material, can then be removed immediately before inserting the shear web into the collet.

In accordance with one embodiment, a connecting profile with a collet for the at least one shear web is used to connect the at least one shear web with the second girder, wherein this connecting profile is glued to the second girder and a lateral surface of the at least one shear web. The connecting profiles which are glued to the two girders, can thereby optionally be glued to the at least one shear web in one working step.

### BRIEF DESCRIPTION OF THE FIGURES OF THE DRAWINGS

The invention is explained in greater detail below based on exemplary embodiments shown in figures. The drawings show in:

FIG. 1 a detail of a rotor blade in cross-section according to the invention,

FIG. 2 a)-d) cross-sections of different connecting profiles,

FIG. 3 a)-g) the steps of the method based on a schematic cross-sectional drawing of a rotor blade according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

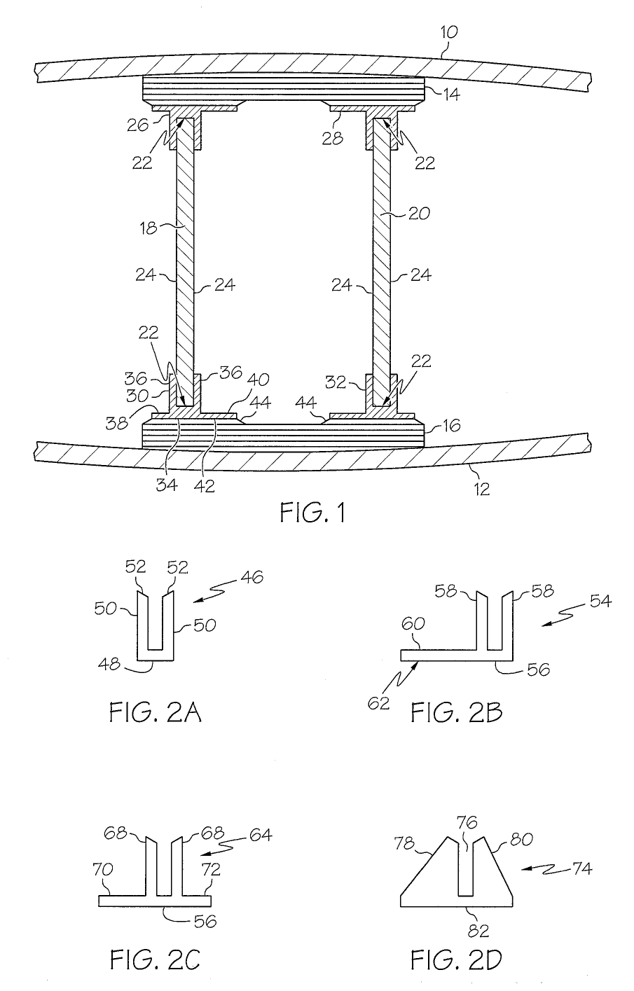

FIG. 1 shows a detail of a cross-section through a rotor blade according to the invention. The upper half shell 10 which forms the aerodynamic casing of the rotor blade, is indicated in the upper part of the figure. Accordingly, the bottom half shell 12 of the rotor blade is located in the bottom part of the figure. A girder 14 of the rotor blade is permanently joined to the first half shell 10 and a girder 16 of the rotor blade to the second half shell 12. The two girders 14, 16 each consist of a plurality of glass plies which are e.g. saturated with a polyester or epoxy resin and thus form to a laminate. The girders 14, 16 are arranged in the area of the largest profile height of the rotor blade and extend it its longitudinal direction. The two girders 14, 16 lie opposite each other.

The two girders 14, 16 are permanently connected with each other by two shear webs 18, 20 which extend between the two girders 14, 16 in the longitudinal direction of the rotor blade. Each of the shear webs 18, 20 has two front surfaces 22 and two lateral surfaces 24.

Furthermore, there are four connecting profiles 26, 28, 30 and 32. The connecting profiles 26 and 28 connect the shear web 18 or 20 with the girder 14. The connecting profiles 30 and 32 connect the shear web 18 or 20 with the girder 16. Each of the connecting profiles 26, 28, 30, 32 is one-piece in cross-section. The cross-section of each connecting profile 26, 28, 30, 32 has a U-shaped section with a base 34 and two legs 36, as can be seen for example in connecting profile 30. Widenings 38, 40 connect to the base 34 of the U profile on both sides, the outer ends of which determine the width of the connecting profile 30 and the width of a first surface 42 of the connecting profile 30 which is glued to the girder 16. Glue 44, in particular based on an epoxy resin, is arranged between the first surface 42 of the connecting profile 30 and the girder 16. The widening 40 is approximately double the width of the widening 38. The widening 38 extends from the base 34 of the U-shaped section in the direction of a lateral edge of the girder 16, while the other widening 40 of the connecting profile 30 extends from the base 34 of the connecting profile 30 in the direction of the middle of the girder 16. The base 34 of the U-shaped section of the connecting profile 30 and the two widenings 38, 40 together form a base plate of the connecting profile 30, the bottom surface 42 of which is even.

The base 34 and the two legs 36 of the U-shaped section of the connecting profile 30 form a collet for a bottom end of the shear web 18. The inside of a leg 36 forms a second surface of the connecting profile which is glued to a lateral surface 24 of the shear web 18. The inside of the opposite-lying leg 36 is also glued to the shear web 18, namely with its opposite-lying lateral surface 24. Glue is located both between the inside of the base 34 and the front surface 22 of the shear web 18 and erbetween the insides of the legs 36 and the lateral surfaces 24.

The above explanations on the structure of the connecting profile 30 and its connection with the girder 16 and the shear web 18 apply similarly for the other connecting profiles 26, 28 and 32.

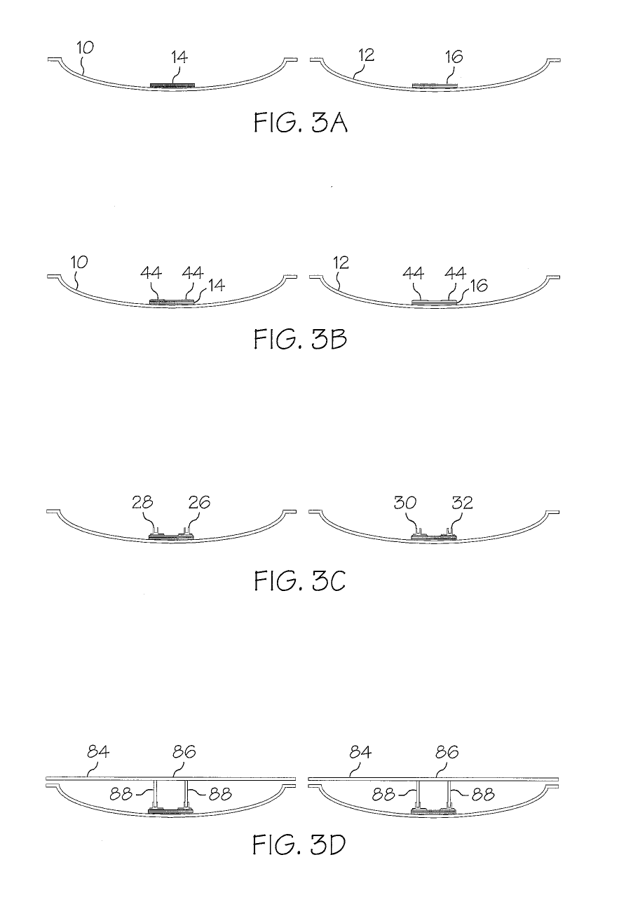

FIG. 2 shows possible embodiments of connecting profiles with different cross-sections. Part a) of FIG. 2 shows a connecting profile 46 with a U-shaped cross-section. It has a base 48 and two legs 50 which are connected to each other. The two legs 50 run in parallel orientation and at a right angle to base 48. The ends of the two legs 50 distant from the base 48 each have a surface 52 which is tilted towards the collet formed between the two legs 50 and the base 48. Another connecting profile 54 is shown in cross-section in part b) of FIG. 2. It too has a U-shaped section with a base 56 and two legs 58. Additionally there is also a widening 60 which connects laterally to the base 56 and creates an enlarged first surface 62 which is provided for the connection with a girder.

In the example of part c) in FIG. 2, another connecting profile 64 is shown which also has a U-shaped section with a base 66 and two legs 68, as already explained with respect to part a) of the figure. Widenings 70, 72 are provided on both sides of the base 66. The widening 70 has a larger width than the widening 72. The widenings 70, 72 together with the base form an even base plate of the connecting profile 64.

The connecting profile 74 shown in part d) of FIG. 2 has an overall almost triangular, one-piece cross-section. In the area of a point of the triangle pointing upwards, a collet 76 is provided, on both sides of which triangular sections 78, 80 of the connecting profile 74 are arranged. The two triangular sections 78, 80 are connected through a base 82 or are both arranged on an imagined base plate 82.

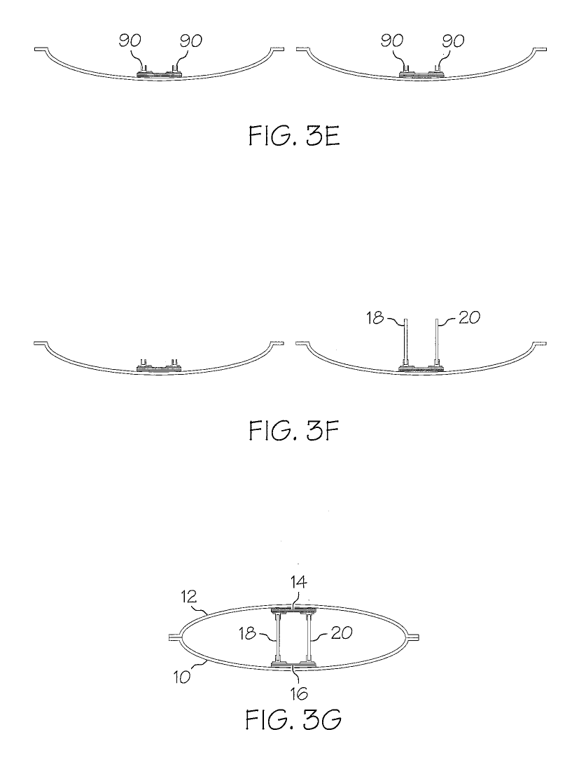

The steps of the method according to the invention are explained based on FIG. 3. Part a) of FIG. 3 shows two half shells 10, 12 of a rotor blade arranged next to each other which can be located in the molds used for producing the half shells 10, 12 which are not shown in detail. The two half shells 10, 12 are arranged next to each other, wherein the sides of the half shells 10, 12 facing the inside of the rotor blade point upwards. The half shell 10 has a girder 14 running approximately in its middle in the longitudinal direction of the rotor blade, the half shell 12 has a girder 16 running approximately in its middle also in the longitudinal direction of the rotor blade.

Glue 44 is applied to the girders 14, 16 in part b) of FIG. 3. The glue 44 is arranged in stripes near the two lateral edges of the girder 14, 16 in the provided contact area to the connecting profiles 26, 28, 30, 32.

In addition to the parts already described, the connecting profiles 26, 28, 30 and 32 are brought on the previously applied glue 44 in part c) of the figure. The connecting profiles 26, 28, 30, 32 are each arranged such that the collets formed between the two legs for the shear webs face the inside of the rotor blade.

Part d) of the figure shows the exact positioning of the connecting profiles 26, 28, 30, 32 by means of two positioning aids. The positioning aids are mechanical holders 84, each of which has a cross member 86 and two supports 88 fastened on it and facing downwards. Each of the supports 88 engages with a collet of a connecting profile 26, 28, 30, 32 and thus determines the position of the respective connecting profile 26, 28, 30, 32. The cross members 86 of the holders 84 are each supported in a defined position on the edges of the half shells 10, 12 or on the edges of the associated molds. An exact positioning of the connecting profiles 26, 28, 30, 32 with respect to the half shells 10, 12 is thereby ensured.

After curing of the glue 44, the holders 84 are removed and—as shown in part e) of the figure—the collets of the connecting profiles 26, 28, 30, 32 are filled with glue 90 to a defined level.

As shown in part f) of FIG. 3, the shear webs 18, 20 are then inserted into the collets of the connecting profiles 30, 32, if necessary with the help of a suitable shear web placement device. They are thereby dipped in the glue 90 such that it is distributed between the boundary surfaces of the collets and the neighboring front and lateral surfaces of the shear webs 18, 20.

In the last step of the process, the result of which is shown in part g) of the figure, the half shell 10 is folded onto the half shell 12, wherein the edges of the half shells 10, 12 are glued to each other. At the same time, the shear webs 18, 20 are inserted into the connecting profiles 26, 28 connected to the girder 14, more precisely into the collets formed by them, and glued into them. After the glue 90 has cured, the two girders 14, 16 are permanently connected with the shear webs 18, 20.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A rotor blade for a wind turbine comprising at least one pair of girders (14, 16) lying opposite each other which extend in the longitudinal direction of the rotor blade and carry forces acting on the rotor blade, and at least one shear web (18, 20) which has two front surfaces (22), each of which is facing one of the two girders (14, 16), and two lateral surfaces (24), wherein that shear web extends between the two girders (14, 16) in the longitudinal direction of the rotor blade and is permanently joined to the two girders (14, 16), wherein at least one connecting profile (26, 28, 30, 32) having a single- or multi-piece cross-section is running in the longitudinal direction of the rotor blade and comprises a collet, into which the at least one shear web (18, 20) is inserted, wherein a first surface (42) of the connecting profile (26, 28, 30, 32) is glued to one of the girders (14, 16) and a second surface of the connecting profile (26, 28, 30, 32) is glued to a lateral surface (24) of the at least one shear web (18, 20).

2. The rotor blade of claim 1, wherein the collet is a groove in the connecting profile (26, 28, 30, 32).

3. The rotor blade of claim 1, wherein a third surface of the connecting profile (26, 28, 30, 32) is glued to a second lateral surface (24) of the at least one shear web (18, 20) lying opposite the first lateral surface (24).

4. The rotor blade of claim 1, wherein the connecting profile is two-piece in cross-section and consists of two profiles arranged next to each other.

5. The rotor blade of claim 1, wherein the connecting profile (26, 28, 30, 32) is one-piece in cross-section with a U-shaped section which has a base (34) and two legs (36) which form the collet.

6. The rotor blade of claim 5, wherein the first surface of the connecting profile (26, 28, 30, 32) is formed by the outside of the base (34) of the U-shaped section.

7. The rotor blade of claim 5, wherein the connecting profile (26, 28, 30, 32) in cross-section has at least one widening (38, 40) which connects laterally to the base (34) of the U-shaped section.

8. The rotor blade of claim 5, wherein the ends of the legs (36) distant from the base (34) in the cross-section of the connecting profile (26, 28, 30, 32) are tilted towards the collet.

9. The rotor blade of claim 1, wherein a front surface (22) of the at least one shear web (18, 20) is glued to the connecting profile (26, 28, 30, 32).

10. The rotor blade of claim 1, wherein the connecting profile (26, 28, 30, 32) consists of a fiber-reinforced plastic material.

11. The rotor blade of claim 1, wherein several connecting profiles (26, 28, 30, 32) are placed side by side in the longitudinal direction of the rotor blade.

12. The rotor blade of claim 1, wherein the cross-section of the connecting profile (26, 28, 30, 32) changes in the longitudinal direction of the rotor blade.

13. The rotor blade of claim 1, wherein the at least one shear web (18, 20) is also connected with the opposite-lying girder (16) via a connecting profile (30, 32), wherein the connection is designed according to one of the above claims.

14. A method for the production of a rotor blade for a wind turbine comprising the steps: providing a first half shell (12) which has a first girder (16) which extends in the longitudinal direction of the rotor blade and carries forces acting on the rotor blade, glueing a first surface of a connecting profile (30, 32) to the first girder (16), wherein the connecting profile (30, 32) has a one- or multiple-piece cross-section and is arranged in the longitudinal direction of the girder, inserting at least one shear web (18, 20) which has a front surface (22) which faces the first girder (16) in a finished rotor blade and two lateral surfaces (24), into a collet of the connecting profile (30, 32), glueing a second surface of the connecting profile (30, 32) to a first lateral surface (24) of the at least one shear web (18, 20), connecting a second half shell (10) which has a second girder (14) lying opposite the first girder (16) in the finished rotor blade, with the first half shell (12) and the at least one shear web (18, 20).

15. The method of claim 14, wherein a positioning aid is used when glueing the first surface of the connecting profile (30, 32) to the first girder (16) and/or the second surface of the connecting profile (30, 32) to the first lateral surface (24) of the at least one shear web (18, 20).

16. The method of claim 14, wherein the collet of the connecting profile (30, 32) is filled with glue (90) up to a predetermined fill level before the insertion of the at least one shear web (18, 20).

17. The method of claims 14, wherein a connecting profile (26, 28) is also used for the connection of the at least one shear web (18, 20) with the second girder (14), wherein this connecting profile (26, 28) is glued to the second girder (14) and a lateral surface of the at least one shear web (18, 20).

18. The method of claim 14, wherein the elements of the rotor blade are designed according to one of claims 1 to 13.
